(19) United States
(12) Patent Application Publication
(10) Pub. No.: US 2023/0376749 A1
(43) Pub. Date: Nov. 23, 2023

(54) SYSTEMS AND METHODS TO LEARN CONSTRAINTS FROM EXPERT DEMONSTRATIONS

(71) Applicants: Ashish GAURAV, Waterloo (CA); Pascal POUPART, Kitchener (CA); Kasra REZAEE, Kitchener (CA); Guiliang LIU, Shenzhen (CN)

(72) Inventors: Ashish GAURAV, Waterloo (CA); Pascal POUPART, Kitchener (CA); Kasra REZAEE, Kitchener (CA); Guiliang LIU, Shenzhen (CN)

(21) Appl. No.: 17/968,913

(22) Filed: Oct. 19, 2022

Related U.S. Application Data
(60) Provisional application No. 63/343,515, filed on May 18, 2022.

(51) Int. Cl. G06N 3/08; B60W 60/00; B60W 50/06

(52) U.S. Cl. CPC G06N 3/08; B60W 60/001; B60W 50/06

(57) ABSTRACT

Methods, systems, and computer-readable media for using inverse reinforcement learning to learn constraints from expert demonstrations are disclosed. The constraints may be learned as a constraint function in two alternating procedures, namely policy optimization and constraint function optimization. Neural network constraint functions may be learned which can represent arbitrary constraints. Embodiments are disclosed that work in all types of environments, with either discrete or continuous state and action spaces. Embodiments are disclosed that may scale to a large set of demonstrations. Embodiments are disclosed that work with any forward CRL technique when finding the optimal policy.

### RELATED APPLICATION DATA

The present application claims priority to U.S. provisional patent application No. 63/343,515, filed May 18, 2022, the entire contents of which are incorporated herein by reference.

### FIELD

The present disclosure relates to machine learning, including systems and methods for learning constraints from expert demonstrations using inverse constraint learning.

### BACKGROUND

Reinforcement learning is a machine learning technique oriented toward solving planning problems. A planning problem (also called a planning optimization problem) can be defined as the problem of making sequential decisions (also called actions) from an initial state that maximize a cumulative reward function. A planning problem is also defined by its state transitions and the constraints on its states and actions. In a simplified form, a planning optimization problem can be written as:

$${max}_{{a}_{0} , … , {a}_{t - 1}} {\sum }_{t = 0}^{T} r ( {s}_{t} , {a}_{t} )$$

$$subject to :$$

$${s}_{t + 1} = f ( {s}_{t} , {a}_{t} )$$

$$c ( {s}_{t} , {a}_{t} ) \leq 0$$

wherein so is the initial state, α₀, . . . , αₜ₋₁ are the sequential decisions to be made, r(sₜ, αₜ) is the reward for being in state sₜ and taking action αₜ, ƒ(sₜ, αₜ) is the transition function that defines the next state for a given action, and c(sₜ, αₜ) is the constraint function defining whether action at can be taken in state sₜ. Note that if a state does not have any valid actions, that state itself would not be valid. An example of these function in autonomous driving could be defined as follows: r(sₜ, αₜ) is the function that defines the trade-off between comfort, mobility and safety; ƒ(sₜ, αₜ) defines the vehicle dynamic and kinematics (how the vehicle will move for a given acceleration and steering pattern); and c(sₜ, αₜ) defines movements that are not allowed such as driving off the road, getting into a collision, accelerating toward a red traffic light, etc.

While the function ƒ(sₜ, αₜ) is typically straightforward to learn from data, the reward function r(sₜ, αₜ) and constraint function c(sₜ, αₜ) are often more difficult to define. An engineer designing the planning solution (i.e. the solution to the planning problem), using a technique such as reinforcement learning, needs to adjust the functions r(·) and c(,) so that the resulting behavior matches expectations. This may become very demanding and complicated for complex problems, such as planning problems in autonomous driving.

An alternative approach to having experts define the functions of the planning problem is to infer these functions from demonstrations. This is often called Inverse Optimal Control or Inverse Reinforcement Learning (IRL). Most algorithms in this field ignore the constraints c(·) and only identify a single reward function r(·). It is possible that the constraint function can be incorporated into the reward and can be removed as a separate constraint. Thus, certain behaviour can be easily represented by constraint functions compared to reward functions, and in these cases it is more convenient to learn constraint functions directly, assuming a reward is known. These techniques may be referred to as inverse constraint learning (ICL), and may be regarded as a sub-type of inverse reinforcement learning.

Learning constraints from demonstrations presents some challenges. Constraints are the states and actions that are avoided in the demonstrations, so they are absent from the demonstration examples. At the same time, not every state or action absent from demonstrations is a constraint.

Techniques for learning constraints from demonstrations has been previously addressed in the IRL literature. Some existing approaches learn a constraint set which explicitly contains all unsafe states. Other approaches impose structure on the constraint function, such as a decision tree structure, a sum of squares or kernel parameterization, etc. Recent approaches have started using neural networks, which are more powerful parameterizations that can represent arbitrary constraints, even though they are not as interpretable. One example of such recent approaches is described by (Anwar, U., Malik, S., Aghasi, A., & Ahmed, A. (2020). Inverse constrained reinforcement learning. arXiv preprint arXiv:2011.09999, hereinafter “Anwar et al.”).

Initial methods to learn constraints formulated the problem as an integer program, a mixed integer program, or a quadratic program and tried to do exact optimization using a solver. This means that the approach does not scale to a large demonstration set (since it would lead to a large number of constraints in the program). Newer methods have retained this formulation and proposed iterative strategies to solve the problem.

More recent work, such as Anwar et al., uses the maximum entropy formulation of the problem and then proposes iterative strategies to solve it. Solutions to the maximum entropy formulation scale to large demonstration sets.

In some cases, the problem of learning constraints from demonstrations can be formulated as follows: given access to an environment E, a reward function r, and a set D of expert demonstrations (which are sequences of state-action pairs, indicating the action taken by the expert in the requisite state), wherein each demonstration in D could have any length, the objective is to discover or learn a constraint function c such that when forward constrained reinforcement learning (CRL) is performed in the environment E with the reward r and the learned constraint c to obtain a policy n, this policy is as similar to the expert policy as possible.

As described above, the approach disclosed in Anwar et al. is based on a maximum entropy formulation of the problem. This approach solves the formulated problem in two alternating steps: policy optimization and constraint function optimization. For policy optimization, Anwar et al. uses constrained policy optimization as described by (Tessler, C., Mankowitz, D. J., & Mannor, S. (2018). Reward constrained policy optimization. arXiv preprint arXiv:1805.11074, hereinafter “Tessler et al.”). For constraint function optimization, Anwar et al. uses an optimization objective defined according to their problem formulation, then use importance sampling to compute this objective, and perform early stopping in their procedure.

The maximum entropy based approach used by Anwar et al. exhibits a number of limitations. First, it assumes a deterministic Markov decision processes (MDP) to formulate the probability of the dataset following a set of constraints. This assumption is not realistic, as most MDPs encountered in practice have a transition distribution that must also be accounted for in the formulation.

Second, the approach used by Anwar et al. can only work with hard constraints. Hard constraints are of two types: cumulative hard constraints must be satisfied in every trajectory, whereas instantaneous hard constraints must be satisfied in every time step. Thus, in terms of the constraint function, an instantaneous hard constraint means that the agent can never take an action in a state with a positive constraint value. Hard constraints tend to restrict the learned policy and the constraint function to be pessimistic or conservative. In real applications, it may be optimal to allow some risk-taking behavior in order to achieve the objective at hand. Thus, it may be optimal in some cases to allow learning of soft constraints, which need not be satisfied in every time step or even in every trajectory, but which are on average satisfied across a set of all trajectories.

Third, an empirical disadvantage of the approach used by Anwar et al. is that it may take a long time to converge (for certain simple environments, it could take days) and requires a significant amount of hyperparameter tuning, which restricts its practical application. Hyperparameter tuning is required for the regularization constant, as well as for the forward and reverse constants used in early stopping.

Thus, there exists a need for techniques for learning constraints from expert demonstrations that overcome one or more of the limitations of the existing approaches described above.

### SUMMARY

In various examples, the present disclosure describes methods, systems, and computer-readable media for using inverse reinforcement learning to learn constraints from expert demonstrations.

Examples described herein may adopt some of the features of the existing approach disclosed by Anwar et al., described above. Some embodiments described herein may solve the formulated problem in two alternating procedures, namely policy optimization and constraint function optimization. Some embodiments described herein may learn neural network constraint functions, which can represent arbitrary constraints, even if, in practice, the output of the constraint function may be bound to values between 0 and 1. Some embodiments described herein may work on all types of environments, with either discrete or continuous state and action spaces. Some embodiments described herein may scale to a large set of demonstrations. And some embodiments described herein may work with any forward CRL technique when finding the optimal policy.

However, embodiments described herein may differ from the existing approach of Anwar et al. in one or more key respects. Some embodiments can be applied to planning problems defined by non-deterministic MDPs. This may enable the identification of soft constraints. It may also result in faster convergence and less need for hyperparameter tuning. Furthermore, whereas the existing approach of Anwar et al. uses only simple constraints (e.g., “X<3” or “Y>2”), examples described herein may learn constraints that are more complex, and therefore more practical and realistic.

Thus, example embodiments described herein may solve one or more of the following technical problems: identifying constraints from expert demonstrations of planning problems defined by non-deterministic MDPs, identifying soft constraints from expert demonstrations of planning problems, reducing convergence time for identifying constraints from expert demonstrations, and/or reducing required hyperparameter tuning for identifying constraints from expert demonstrations.

It will be appreciated that the simplified formulation of a planning problem described in the Background section above uses a deterministic transition function, i.e. one state-action pair leads to one deterministic next state. However, some examples described herein are also capable of handling stochastic transitions. Furthermore, the constraint c≤0 in the simplified formulation above is an instantaneous hard constraint that must be satisfied for every state-action pair, but some examples described herein find cumulative soft constraints that are satisfied in expectation across trajectories. Accordingly, some embodiments described herein may instead use the following formulation of a planning problem:

$${max}_{{a}_{0} , … , {a}_{t - 1} {E}_{{s}_{t} \sim P ( \cdot \vert {s}_{t - 1} , {a}_{t - 1} )}} [ {\sum }_{t = 0}^{T} r ( {s}_{t} , {a}_{t} ) ]$$

$$subject to :$$

$${s}_{0} : initial state$$

$${E}_{{s}_{t} \sim P ( \cdot \vert {s}_{t - 1} , {a}_{t - 1} )} [ c ( {s}_{t} , {a}_{t} ) ] \leq 0$$

As described above, some embodiments described herein may apply two alternating optimization procedures to solve the problem of identifying constraints from demonstrations (such as expert demonstrations). The first procedure is policy optimization. It fixes the constraint function c and performs CRL with the given reward r to obtain a policy n. The second procedure is constraint function optimization, which first updates a mixture policy with the newly obtained policy n (from the previous procedure), then uses this mixture policy to generate a dataset of undesirable behavior A, and finally uses this generated dataset A and the expert dataset D to update the constraint function c.

The process starts with random parameters for n and c and updates them through these two procedures, for a fixed number of epochs (typically less than 20 epochs). Finally, the algorithm outputs the learned constraint function c. At convergence, the obtained policy n should be the same as the expert policy which was used to generate D.

As used herein, the term “constraint function” refers to a function which specifies whether some behavior (i.e., taking an action in a given state) is allowed or not.

As used herein, the term “policy” refers to a set of rules or procedures operable to determine an action for an agent based on a current state of the agent's environment.

As used herein, the term “threshold” refers to a limit on a value. The threshold may be a lower limit, an upper limit, an absolute limit of absolute magnitude, or any other limit. Statements that a value is “within” a threshold refer to the value being within a region bounded by the threshold.

As used herein, the term “Markov decision process” (MDP) refers to a formalism that can be used to define a decision problem in terms of the states, the actions (also called decisions) that may be taken in those states, and the rewards obtained on executing actions in various states. The states transition according to a transition distribution. An MDP is defined as a tuple (S, A, p, μ, r, γ), wherein S is the state space, A is the action space, p(·|s, α) are the transition probabilities over the next states given the current states and current action α, r: S×A→ [symbol] is the reward function, μ: S→[0,1] is the initial state distribution and γ is the discount factor. The behavior of an agent in this MDP can be represented by a stochastic policy π: S× A→[0,1], which is a mapping from a state to a probability distribution over actions. A constrained MDP (CMDP), as described by (Tessler et al.), augments the MDP structure to contain a constraint function c:S×A→ [symbol] and an episodic constraint threshold β.

As used herein, the term “reinforcement learning” (RL), refers to a process wherein, given access to an environment and a reward function, the objective is to learn an optimal policy that maximizes the long-term episodic discounted reward. Reinforcement learning can thereby be formulated as:

$${π}^{*} = arg {max}_{π} {𝔼}_{{s}_{0} \sim μ ( \cdot ) , {a}_{t} \sim π ( \cdot \vert {s}_{t} ) , {s}_{t} + 1 \sim p ( \cdot \vert {s}_{t} , {a}_{t} )} {\sum }_{t = 0}^{∞} {γ}^{t} r ( {s}_{t} , {a}_{t} ) = : {J}_{μ}^{π} ( r ) \qquad ( Equation 1 )$$

As used herein, the term “constrained reinforcement learning” (CRL), refers to a process wherein, given access to a constraint function, an environment, and a reward function, the objective is to learn an optimal policy that maximizes the long-term episodic discounted reward while obeying the constraints. Constrained reinforcement learning can thereby be formulated as:

$${π}^{*} = arg {max}_{π} {J}_{μ}^{π} ( r ) such that {J}_{μ}^{π} ( {c}_{i} ) \leq {β}_{i} {∀}_{i} \qquad ( Equation 2 )$$

As used herein, the term “inverse reinforcement learning” (IRL) refers to the inverse procedure of reinforcement learning. Given access to an environment and demonstrations from an optimal expert, the objective is to learn a reward function that best explains the given demonstrations.

As used herein, the term “inverse constraint learning” (ICL), refers to a process wherein, given access to an environment, demonstrations from an optimal expert following constrained behavior, and a reward function, the objective is to learn a constraint function which, when paired with the given reward function, best explains the given constrained demonstrations. ICL as described herein may be formulated as follows: given access to a dataset D, which is sampled using an optimal or near optimal policy π* (respecting some constraint function cᵢ and maximizing some known reward r), the goal is to obtain the constraint functions cᵢ that best explain the dataset, that is, if a constrained RL procedure is performed using r, cᵢ∀ᵢ, then the obtained policy captures the behaviour demonstrated in D. In this ICL approach, only the constraint function cᵢ is learned, not the reward function. Essentially, it is difficult to say whether a demonstrated behaviour is obeying a constraint, or maximizing a reward, or doing both. So, for simplicity, this approach to ICL assumes the reward is given, and it is only necessary to learn a constraint function. Without loss of generality, the constraint threshold (also called a cost threshold) β is fixed to a predetermined value, and only a constraint function c is learned. Mathematically equivalent constraints can be obtained by multiplying the constraint function c and the threshold β by the same value. Therefore there is no loss in fixing β to learn a canonical constraint within the set of equivalent constraints.

In some cases, ICL and IRL may be referred to interchangeably in the context of learning constraints from demonstrations.

As used herein, the term “mixture policy” refers to a policy used by a reinforcement learning (or CRL, IRL, or ICL) algorithm to simultaneously optimize or balance multiple conflicting objectives. A mixture policy is typically implemented as a weighted collection of multiple policies, wherein the weight is used in computing a combined objective or quantity. To generate trajectories using an agent following a mixture policy, the agent makes decisions by combining the policies in proportion to their weight, wherein the weights typically sum to 100%. Thus, when a mixture of policies or a set of policies is learned by a reinforcement learning agent as described herein, the mixture or set of policies may be also include a corresponding weight for each policy in the mixture or set of policies.

As used herein, the term “trajectory” may refer to a sequence of states resulting from a sequence of action taken by an agent, or to the sequence of (state, action) pairs corresponding thereto. In the context of motion planning in the problem domain of autonomous driving, a “trajectory” may refer to a literal physical trajectory of the vehicle being driven by an agent, i.e., the sequence of positional states of the vehicle resulting from a sequence of steering and acceleration/deceleration actions. In the context of a demonstration, the “trajectory” may refer to an observed trajectory generated by the entity (such as an expert) performing the demonstrations, such that a trajectory consisting of a sequence of (state, action) pairs may be inferred from the demonstration.

As used herein, the term “demonstration” may refer to data representative of performance of a task by an entity, such as an expert, such that a sequence of (state, action) pairs may be inferred therefrom.

As used herein, the term “model” may refer to a mathematical or computational model. A model may be said to be implemented, embodied, run, or executed by an algorithm, computer program, or computational structure or device. In the present example embodiments, unless otherwise specified a model refers to a “machine learning model”, i.e., a predictive model implemented by an algorithm trained using deep learning or other machine learning techniques, such as a deep neural network (DNN).

As used herein, the term “machine learning” (ML) may refer to a type of artificial intelligence that makes it possible for software programs to become more accurate at making predictions without explicitly programming them to do so.

As used herein, an “input sample” may refer to any data sample used as an input to a machine learning model, such as image data. It may refer to a training data sample used to train a machine learning model, or to a data sample provided to a trained machine learning model which will infer (i.e. predict) an output based on the data sample for the task for which the machine learning model has been trained. Thus, for a machine learning model that performs a task of image classification, an input sample may be a single digital image.

As used herein, the term “training” may refer to a procedure in which an algorithm uses historical data to extract patterns from them and learn to distinguish those patterns in as yet unseen data. Machine learning uses training to generate a trained model capable of performing a specific inference task.

As used herein, a statement that an element is “for” a particular purpose may mean that the element performs a certain function or is configured to carry out one or more particular steps or operations, as described herein.

As used herein, statements that a second element is “based on” a first element may mean that characteristics of the second element are affected or determined at least in part by characteristics of the first element. The first element may be considered an input to an operation or calculation, or a series of operations or computations, which produces the second element as an output that is not independent from the first element.

In some aspects, the present disclosure describes a method for learning a constraint function consistent with a demonstration. Demonstration data representative of the demonstration is obtained. The demonstration data comprises a sequence of actions. Each action is taken in the context of a respective state of a demonstration environment. An initial policy is obtained. The initial policy is operable to determine an action for an agent based on a current state of an agent environment, such that a current policy is set to the initial policy. An initial constraint function is obtained, such that a current constraint function is set to the initial constraint function. A policy optimization procedure is performed to adjust the current policy, thereby generating an adjusted policy. The adjusted policy is added to a set of policies. A constraint function optimization procedure is performed to: generate a mixture policy, based on the set of policies, that defines a second utility comprising the current constraint function applied to the mixture policy, and adjust the current constraint function to maximize the second utility, such that a third utility is within a constraint threshold. The third utility is the current constraint function applied to the demonstration data. The current constraint function is provided as the constraint function.

In some aspects, the present disclosure describes a system, comprising a processing device and a memory. Stored on the memory are machine-executable instructions that, when executed by the processing device, cause the system to learn a constraint function consistent with a demonstration. Demonstration data representative of the demonstration is obtained. The demonstration data comprises a sequence of actions. Each action is taken in the context of a respective state of a demonstration environment. An initial policy is obtained. The initial policy is operable to determine an action for an agent based on a current state of an agent environment, such that a current policy is set to the initial policy. An initial constraint function is obtained, such that a current constraint function is set to the initial constraint function. A policy optimization procedure is performed to adjust the current policy, thereby generating an adjusted policy. The adjusted policy is added to a set of policies. A constraint function optimization procedure is performed to: generate a mixture policy, based on the set of policies, that defines a second utility comprising the current constraint function applied to the mixture policy, and adjust the current constraint function to maximize the second utility, such that a third utility is within a constraint threshold. The third utility is the current constraint function applied to the demonstration data. The current constraint function is provided as the constraint function.

In some examples, the method further comprises, before providing the adjusted constraint function as the constraint function: repeating, one or more times, the steps of performing the policy optimization procedure, adding the adjusted policy to the set of policies, and performing the constraint function optimization procedure.

In some examples, performing the policy optimization procedure comprises adjusting the current policy to maximize a first utility comprising a reward function applied to the current policy, such that the second utility is within a constraint threshold.

In some examples, adjusting the current policy to maximize the first utility such that the second utility is within the constraint threshold comprises: performing constrained optimization using forward constrained reinforcement learning.

In some examples, the forward constrained reinforcement learning uses vanilla gradient descent.

In some examples, the constraint function optimization procedure uses vanilla gradient descent to adjust the current constraint function to maximize the second utility.

In some examples, the constraint function optimization procedure comprises: training a neural network to optimize the second utility while maintaining the third utility within the constraint threshold.

In some examples, generating the mixture policy comprises computing a weighted mixture of the set of policies.

In some examples, the demonstration data comprises a plurality of expert trajectories. Applying the current constraint function to the current policy comprises: generating agent data, comprising a plurality of agent trajectories based on the mixture policy, and computing the second utility by applying the current constraint function to the plurality of agent trajectories. Applying the current constraint function to the demonstration data comprises: computing the third utility by applying the current constraint function to each expert trajectory of the plurality of expert trajectories.

In some examples, the method further comprises operating an autonomous driving system by operating a motion planner of the autonomous driving system in accordance with the constraint function.

In some aspects, the present disclosure describes an autonomous driving system, comprising a motion planner configured to operate in accordance with a constraint function learned in accordance with one or more of the methods described above.

In some aspects, the present disclosure describes a non-transitory computer-readable medium having instructions tangibly stored thereon that, when executed by a processing device of a computing system, cause the computing system to learn a constraint function consistent with a demonstration. Demonstration data representative of the demonstration is obtained. The demonstration data comprises a sequence of actions. Each action is taken in the context of a respective state of a demonstration environment. An initial policy is obtained. The initial policy is operable to determine an action for an agent based on a current state of an agent environment, such that a current policy is set to the initial policy. An initial constraint function is obtained, such that a current constraint function is set to the initial constraint function. A policy optimization procedure is performed to adjust the current policy, thereby generating an adjusted policy. The adjusted policy is added to a set of policies. A constraint function optimization procedure is performed to: generate a mixture policy, based on the set of policies, that defines a second utility comprising the current constraint function applied to the mixture policy, and adjust the current constraint function to maximize the second utility, such that a third utility is within a constraint threshold. The third utility is the current constraint function applied to the demonstration data. The current constraint function is provided as the constraint function.

In some aspects, the present disclosure describes a non-transitory computer-readable medium having instructions tangibly stored thereon that, when executed by a processing device of a computing system, cause the computing system to perform one or more of the methods described above.

### BRIEF DESCRIPTION OF THE DRAWINGS

Reference will now be made, by way of example, to the accompanying drawings which show example embodiments of the present application, and in which:

FIG. 1 is a block diagram of an example computing system that may be used to implement examples described herein.

FIG. 2 is a high-level schematic diagram of the operation of two alternating optimization procedures to compute an optimal constraint policy based on an expert demonstration, in accordance with the present disclosure.

FIG. 3 is a detailed schematic diagram of the constraint learning process of FIG. 2.

FIG. 4 is a schematic diagram of the constraint learning process of FIGS. 2 and 3, implemented as an example constraint learning software system, in accordance with the present disclosure.

FIG. 5 is a schematic diagram of an example autonomous driving system having a motion planning component that operates in accordance with a constraint function determined in accordance with the present disclosure.

FIG. 6 is a flowchart showing operations of a method for learning constraints from demonstrations, in accordance with the present disclosure.

Similar reference numerals may have been used in different figures to denote similar components.

### DESCRIPTION OF EXAMPLE EMBODIMENTS

Methods, systems, and computer-readable media for learning constraints from demonstrations will now be described with reference to example embodiments.

Example Computing System

A system or device, such as a computing system, that may be used in examples disclosed herein is first described.

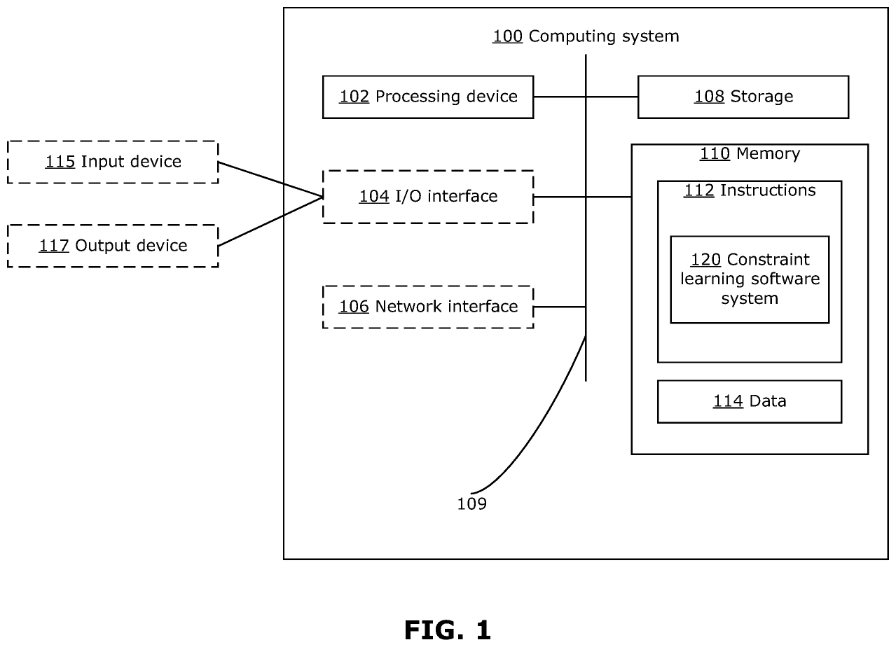

FIG. 1 is a block diagram of an example simplified computing system 100, which may be a device that is used to execute instructions 112 in accordance with examples disclosed herein, including the instructions of a constraint learning software system 120. Other computing systems suitable for implementing embodiments described in the present disclosure may be used, which may include components different from those discussed below. In some examples, the computing system 100 may be implemented across more than one physical hardware unit, such as in a parallel computing, distributed computing, virtual server, or cloud computing configuration. Although FIG. 1 shows a single instance of each component, there may be multiple instances of each component in the computing system 100.

The computing system 100 may include a processing system having one or more processing devices 102, such as a central processing unit (CPU) with a hardware accelerator, a graphics processing unit (GPU), a tensor processing unit (TPU), a neural processing unit (NPU), a microprocessor, an application-specific integrated circuit (ASIC), a field-programmable gate array (FPGA), a dedicated logic circuitry, a dedicated artificial intelligence processor unit, or combinations thereof.

The computing system 100 may also include one or more optional input/output (I/O) interfaces 104, which may enable interfacing with one or more optional input devices 115 and/or optional output devices 117. In the example shown, the input device(s) 115 (e.g., a keyboard, a mouse, a microphone, a touchscreen, and/or a keypad) and output device(s) 117 (e.g., a display, a speaker and/or a printer) are shown as optional and external to the computing system 100. In other examples, one or more of the input device(s) 115 and/or the output device(s) 117 may be included as a component of the computing system 100. In other examples, there may not be any input device(s) 115 and output device(s) 117, in which case the I/O interface(s) 104 may not be needed.

The computing system 100 may include one or more optional network interfaces 106 for wired or wireless communication with a network (e.g., an intranet, the Internet, a P2P network, a WAN and/or a LAN) or other node. The network interfaces 106 may include wired links (e.g., Ethernet cable) and/or wireless links (e.g., one or more antennas) for intra-network and/or inter-network communications.

The computing system 100 may also include one or more storage units 108, which may include a mass storage unit such as a solid state drive, a hard disk drive, a magnetic disk drive and/or an optical disk drive. The computing system 100 may include one or more memories (collectively memory 110), which may include a volatile or non-volatile memory (e.g., a flash memory, a random access memory (RAM), and/or a read-only memory (ROM)). The non-transitory memory 110 may store instructions 112 for execution by the processing device(s) 102, such as to carry out examples described in the present disclosure. The memory 110 may include other software instructions 112, such as for implementing an operating system and other applications/functions. In some examples, memory 110 may include software instructions 112 for execution by the processing device 102 to implement a constraint learning software system 120, as disclosed herein. The non-transitory memory 110 may store data 114, such as data encoding models, demonstrations, states, policies, and/or the various other forms of data described herein (such as a planning problem definition for the planning problem to be solved).

In some other examples, one or more data sets and/or modules may be provided by an external memory (e.g., an external drive in wired or wireless communication with the computing system 100) or may be provided by a transitory or non-transitory computer-readable medium. Examples of non-transitory computer readable media include a RAM, a ROM, an erasable programmable ROM (EPROM), an electrically erasable programmable ROM (EEPROM), a flash memory, a CD-ROM, or other portable memory storage.

There may be a bus 109 providing communication among components of the computing system 100, including the processing device(s) 102, I/O interface(s) 104, network interface(s) 106, storage unit(s) 108 and/or memory 110. The bus 109 may be any suitable bus architecture including, for example, a memory bus, a peripheral bus or a video bus. In some examples, the computing system 100 is a distributed computing system and the functions of the bus 109 may be performed by the network interfaces 106 in communication with communication links.

Example Constraint Learning Software System

Examples described herein may be used in problem domains that require learning behavioral constraints from demonstration. As described briefly above, examples described herein may solve an ICL problem through two alternating optimization procedures: (a) policy optimization, which fixes the constraint function c and performs CRL to obtain a policy π, and (b) constraint function optimization, which updates the mixture policy with π and then obtains the constraint function c. In some examples, the policy optimization procedure may include a relatively large number (e.g., 500) of iterations of a policy optimization algorithm. In some examples, the constraint function optimization procedure may include a relatively small number (e.g., 25) of iterations of a constraint function optimization algorithm. The constraint learning process begins with random parameters for π and c and updates them by performing a first epoch consisting of a single iteration of each of the two optimization procedures; the two optimization procedures are then repeated for a fixed number of epochs (e.g., a fixed number <20 epochs). Finally, the algorithm outputs the learned constraint function c.

There are three utilities, i.e. three variable values, that are optimized or constrained by the process described above. These three utilities represent three objectives, and they are combined to form the mixture policy. The first utility is Jᵣ(π), which is the expected long term discounted reward following the policy π. The second utility is a shared quantity J_{c}(π), which is the expected long term discounted constraint value c following the policy π. (The second utility J_{c}(π) is referred to as a shared quantity because it is used by both the policy optimization procedure and the constraint function optimization procedure.)

The third utility is obtained by fixing the policy to the expert policy π_{E}, which gives us J_{c}(π_{E}). All these utilities are computable quantities, either through simulated agent data A, or through given expert demonstrations D.

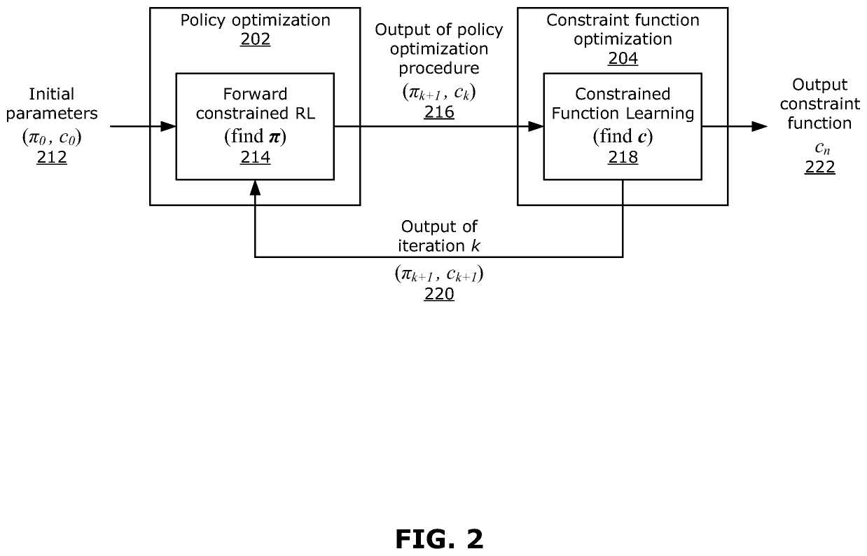

FIG. 2 shows a high-level schematic diagram of the operation of the two alternating optimization procedures to compute an optimal constraint policy based on an expert demonstration.

Initial parameters (π₀, c₀) 212 are received at the beginning of the constraint learning process. The initial parameters 212 include an initialized policy π₀ and an initialized constraint policy c₀, which may be arbitrary or may be in a predetermined initial configuration. The initial parameters 212 are provided as input to the policy optimization procedure 202 at the first iteration of the two alternating optimization procedures (i.e., the first training epoch).

The policy optimization procedure 202, at a high level, solves the CRL problem by optimizing and constraining the first utility Jᵣ(π) and second utility J_{c}(π) respectively. Specifically, based on its input (i.e. a policy and a constraint policy), the policy optimization procedure 202 maximizes Jᵣ(π), while constraining J_{c}(π) to be below a constraint threshold β. As shown in FIG. 2, this constrained optimization is performed by a forward constrained reinforcement learning algorithm 214 to find a policy π that maximizes Jᵣ(π), while constraining J_{c}(π) to be below β. The output 216 of the policy optimization procedure 202 after iteration k of the two alternating optimization procedures is denoted as (πₖ₊₁, cₖ). This output 216 is provided as input to the constraint function optimization procedure 204.

The constraint function optimization procedure 204, at a high level, learns an out-of-distribution classifier, which is a neural network or other trained machine learning model that can infer whether a given state-action pair (s, α) is expert behavior or not, and will produce a high value (i.e., a high constraint value) for a state-action pair that's not likely demonstrating expert behavior. The constraint function optimization procedure 204 learns the out-of-distribution classifier by optimizing and constraining the second and third utilities, that is, maximizing J_{c}(π) (in some embodiments, a mixture of policies may be evaluated), while constraining J_{c}(π_{E}) to be below the constraint threshold β. As shown in FIG. 2, this learning of the out-of-distribution classifier is performed by a constrained function learning algorithm 218 to find a constraint policy c that maximizes J_{c}(π) while constraining J_{c}(π_{E}) to be below β.

It will be appreciated that other approaches to ICL have used a discriminator network as an out-of-distribution classifier to distinguish between expert behavior and other behavior. One such approach is described by Anwar et al., based on an earlier technique described by (Ho, J., & Ermon, S. (2016). Generative adversarial imitation learning. Advances in neural information processing systems, 29). However, these other approaches have not been applied to constraint functions, and in fact, their formulation doesn't allow for optimizing with a specific constraint threshold, unlike embodiments described herein. Thus, unlike these other approaches, the examples described herein use a neural network or other machine learning model as an out-of-distribution classifier to solve the technical problem of learning a constraint function from demonstrations.

The output 220 of the constraint function optimization procedure 204 after iteration k of the two alternating optimization procedures is denoted as (πₖ₊₁, cₖ₊₁). This output 220 is provided as input to the policy optimization procedure 202 for iteration k+1. After a predetermined number of iterations (i.e., training epochs) has been completed, such as n=20 iterations, the constraint function optimization procedure 204 provides its final output 222 as constraint function cₙ. In some examples, the process terminates and generates the final output 222 after another termination condition is satisfied, such as a convergence condition (e.g., if the change in the constraint function c after a training epoch is below a convergence threshold).

Thus, examples described herein perform ICL to obtain a constraint function from demonstrations: given a reward r and demonstrations D, a constraint function c is obtained such that when r, c are used in a constrained reinforcement learning procedure, the obtained policy π* explains the behavior in D. The ICL process starts with an empty set of policies (i.e., Π=Ø) and then alternates between the two optimization procedures until convergence (i.e., when the set n of policies remains unchanged). First, policy optimization is performed:)

π*:=argmax_{π}Jμ^{π}(r) such that J_{μ}^{π}(c)≤βand Π←Π←∪(π*) (Equation 3)

Second, constraint function optimization is performed:

$${c}^{*} := arg {max}_{c} {min}_{π ∈ Π} {J}_{μ}^{π} ( c ) such that {J}_{μ}^{{π}_{E}} ( c ) \leq β \qquad ( Equation 4 )$$

These two procedures are alternated until convergence or another terminating condition is satisfied.

It will be appreciated that the notation J_{c}(π) is the equivalent of J_{μ}^{π}(c); the notation J_{c}(π_{E}) is the equivalent of J_{μ}^{πE}(c); and the notation Jᵣ(π) is the equivalent of J_{μ}^{π}(r). Jᵣ(π) or J_{μ}^{π}(r) may be referred to herein as the first utility or the reward value of the policy π. J_{c}(π) or J_{μ}^{π}(c) may be referred to herein as the second utility or the constraint value of the policy π. J_{c}(π_{E}) or J_{μ}^{πE}(c) may be referred to herein as the third utility or the constraint value of the expert policy π_{E}.

It will be appreciated that, by minimizing the constraint value (also called “cost”) J_{c}(π) with respect to choice of policy π, and maximizing the constraint value J_{c}(π) with respect to choice of constraint function c, while still selecting a constraint function that keeps the expert demonstration's constraint value J_{c}(π_{E}) within the limit of constraint threshold β, the constraint function optimization procedure will select a constraint function c that defines the outer limits of the space defined by the constraints underlying the expert's demonstrated behavior, potentially including soft constraints.

Specifically, the policy optimization procedure in Equation 3 performs forward constrained RL to find an optimal policy π* given a reward function r and a constraint function c. This optimal policy π* is added to the set of policies Π. Then, the constraint function optimization procedure in Equation 4 adjusts the constraint function c to increase the constraint values of the policies in Π (i.e., J_{μ}^{π}(c) for each π∈Π) while keeping the constraint value of the expert policy π_{E} bounded by β (i.e., Jᵣ(c)<Hence, at each iteration of those two optimization procedures, a new policy π* is found, but its constraint value will be increased past β unless it corresponds to the expert policy π_{E}. Hence, this approach will converge to the expert policy π_{E} (or an equivalent policy when multiple policies can generate the same trajectories).

Thus, the alternation of optimization procedures in Equation 3 and Equation 4 converges to a set of policies II such that the last policy π* added to Π is equivalent to the expert policy π_{E} in the sense that π* and π_{E} generate the same trajectories.

Examples describe herein may encompass various implementations of the optimization procedures in Equations 3 and 4. First, examples described herein are not provided with the expert policy π_{E}, but rather are provided with demonstrated trajectories that have been generated based on the expert policy, denoted as expert trajectory data D_{E}. Also, the set Π of policies can grow to become very large before convergence is achieved. Furthermore, convergence may not occur or may occur prematurely due to numerical issues and whether the policy space contains the expert policy π_{E}. The optimization procedures described herein include constraints, and one of them (the constraint function optimization procedure 204) requires min-max optimization. Various embodiments may use different strategies to approximate the theoretical approach in Equations 3 and 4, such as the example method described in Algorithm 1 below.

In some embodiments, the constraint function optimization procedure 204 formulated in Equation 4 can be implemented by a simpler optimization procedure as shown in Equation 5:

c*:=argmax J_{μ}^{πmix}(c)such that J_{μ}^{πE}(c)≤β (Equation 5)

Specifically, the max-min optimization of the constraint values of the policies in Π by a maximization of the constraint value of the mixture πₘᵢₓ of policies in Π. This avoids a challenging max-min optimization, but at the cost of losing the guarantee of convergence to a policy equivalent to the expert policy π_{E}. Nevertheless, maximizing the constraint values of a mixture of policies tends to increase the constraint values for all policies most of the time, and when a policy's constraint value is not increased beyond β it will usually be a policy close to the expert policy π_{E}. Hence, as demonstrated by the experiments described below, example embodiments described herein find policies that are close to the expert policy π_{E} in terms of generated trajectories.

The constrained optimization problems formulated in Equations 3, 4, and 5 above belong to the following general class of optimization problems (wherein ƒ, g are potentially non-linear and non-convex):

$${min}_{y} f ( y ) such that g ( y ) \leq 0 \qquad ( Equation 6 )$$

Donti et al. (described below) propose to solve such problems using a technique called DC3: deep constraint correction and completion. In example embodiments described herein, the completion step of the DC3 algorithm is unnecessary, because there is no constraint h(y)=0 associated with the optimization. Hence, some example embodiments described herein may instead employ an algorithm called deep constraint correction (DC2). DC2 starts by instantiating y=y₀, and then repeating two steps until convergence: (a) first a feasible solution is found by repeatedly modifying y until g(y)≤0, then (b) a soft loss is optimized that simultaneously minimizes ƒ(y) and keeps y within the feasible region. In some examples, a modified soft loss may be used, which yields the following objective for the second step (λ is a hyperparameter):

$${min}_{y} {L}_{soft} ( y ) := f ( y ) + λ ReLU ( g ( y ) ) \qquad ( Equation 7 )$$

The choice of λ may affect the performance of various embodiments. A small λ means that in the second step, the gradient of ReLU(g(y)) does not interfere with the optimization of ƒ(y), however, y may not stay feasible during the soft loss optimization, which is why the correction step is even more important to ensure some notion of feasibility. Conversely, a large λ means that minimizing the soft loss is sufficient to ensure feasibility, and the correction step may be omitted. Thus, some example embodiments described herein may perform approximate forward constrained RL (i.e. policy optimization 202 solving the optimization problem of Equation 3) using λ=0 for the correction step, and perform constraint adjustment (i.e. constraint function optimization 204 solving the optimization problem of Equation 4 or Equation 5) using a large A and without the correction step.

It will be appreciated that constraint adjustment (i.e. constraint function optimization 204 solving the optimization problem of Equation 4 or Equation 5) is equivalent to finding the decision boundary between expert trajectories and non-expert trajectories. The soft loss objective (considering Equation 5) can be formulated as:

$${min}_{c} {L}_{soft} ( c ) := - {J}_{μ}^{{π}_{m i x}} ( c ) + λ ReLU ( {J}_{μ}^{{π}_{E}} ( c ) - β ) \qquad ( Equation 8 )$$

It is quite likely that during training, some of the agent behavior overlaps with expert behavior. This means that some expert trajectories appear in the first term −J_{μ}^{π}^{ₘᵢₓ}(c). This may be problematic if the objective is to learn the decision boundary between expert and non-expert trajectories.

Depending on whether J_{μ}^{π}^{_{E}}(c)−β≤0 or not, the ReLU term vanishes in L_{soft}(c).

Case I. If J_{μ}^{π}^{_{E}}(c)−β≤0, then c is already feasible, that is, for this value of c, the average constraint value across expert trajectories is less than or equal to β. If there are expert (or expert-like) trajectories in −J_{μ}^{π}^{ₘᵢₓ}(c), then the constraint value will be increased across these expert trajectories, which is not desirable since it will lead to c becoming more infeasible.

Case II. If J_{μ}^{π}^{_{E}}(c)−β>0, then there is a nonzero ReLU term in L_{soft}(c). Given that there are some expert trajectories in −J_{μ}^{π}^{ₘᵢₓ}(c), if the gradient of L_{soft}(c) is computed, it will result in two contrasting gradient terms tending to increase and decrease the constraint value across these expert trajectories. The gradient update associated with the ReLU term is more necessary since the objective is for c to become feasible, but having expert trajectories in −J_{μ}^{π}^{ₘᵢₓ}(c) diminishes the effect of the ReLU term and more iterations are required to compute a feasible c.

Overall, it may not be desirable to have expert or expert-like trajectories in −J_{μ}^{π}^{ₘᵢₓ}(c). To mitigate this, in some examples the expectation of −J_{μ}^{π}^{ₘᵢₓ}(c) is reweighted to ensure that there is less or negligible weight associated with the expert or expert-like trajectories. This reweighting can be performed using a density estimator. In some examples, a normalizing flow may be used for this purpose.

Thus, some embodiments may perform constraint learning using an algorithm such as Algorithm 1 below:
Algorithm 1 Inverse Constraint Learning with Trajectory Reweighting
   input: number of iterations n, constrained RL epochs m, learning rate η, constraint adjustment epochs m_{CA}, expert dataset [symbol] , tolerance ∈
1: initialize normalizing flow ƒ
2: optimize likelihood of ƒ on expert state action data: max_{ƒ} [symbol] log p_{ƒ}(s, α)
3: initialize unnormalized policy probabilities w, constraint function c (parameterized by ϕ
4: for 1<i<n do
5: initialize policy πᵢ (parameterized by θ)
6: for 1<j≤m do [symbol] constrained reinforcement learning
7: correct πᵢ to be feasible: (iterate) θ←θ−ηα_{θ}ReLU(J_{μ}^{π}^{ᵢ}(c)−β)
8: optimize expected discounted reward: θ←θ−ηα_{θ}PPO-Loss(πᵢ)
9: end for
10: construct policy dataset D_{π}_{ᵢ}, by sampling trajectories from πᵢ
11:

$${w}_{i} := {Σ}_{τ ∈ {𝒟}_{{π}_{t}}} \{ - \frac{1}{\vert {𝒟}_{{π}_{i}} \vert} log {p}_{f} ( τ ) \}$$

12: construct agent dataset D_{A} by sampling trajectories from π_{1:i} according to probabilities w_{1:i}
13: Z:= [symbol] {−log p_{ƒ}(τ)}
14: for 1<j<m_{ca} do [symbol] constraint function adjustment
15: compute soft loss

$${L}_{soft} ( c ) := - {\sum }_{τ ∈ {𝒟}_{A}} \{ - \frac{1}{Z} log {p}_{f} ( τ ) \} c ( τ ) + λ ReLU ( {J}_{μ}^{{π}_{E}} ( c ) - β )$$

16: optimize constraint function c: ϕ←ϕ−ηα_{ϕ}L_{soft}(c)
17: end for
18: if D_{w}(D, D_{π}_{ᵢ})≤∈ then
19: convergence: may exit early
20: end if
21: end for

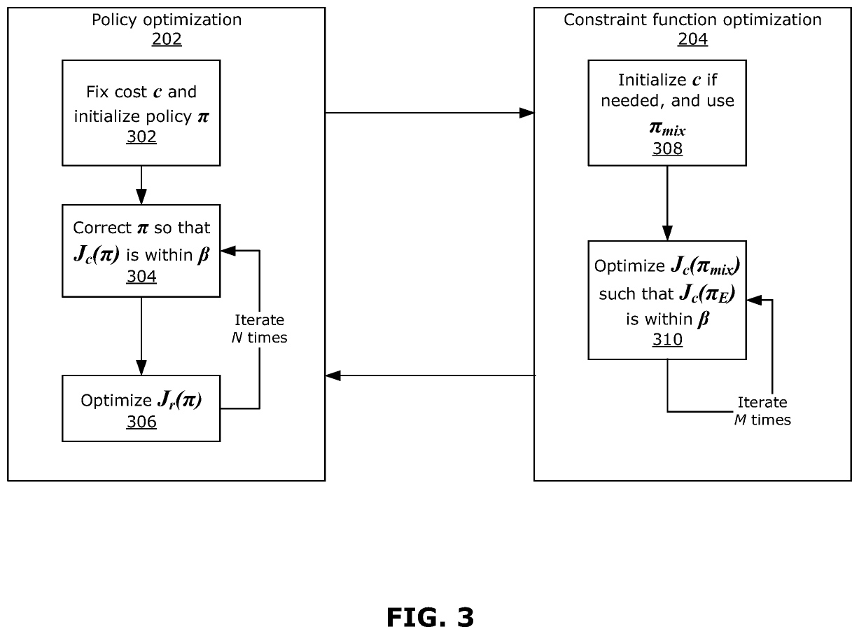

FIG. 3 shows a more detailed schematic diagram of the constraint learning process of FIG. 2. The alternation between policy optimization 202 and constraint function optimization 204 is unchanged from the example of FIG. 2. However, the internal operations of each optimization operation are shown in more detail.

In the example of FIG. 3, both policy optimization 202 and constraint function optimization 204 use a penalty function approach similar to the approach described by (Donti, P. L., Rolnick, D., & Kolter, J. Z. (2021). Dc3: A learning method for optimization with hard constraints. arXiv preprint arXiv:2104.12225, hereinafter “Donti et al.”, hereby incorporated by reference in its entirety) with some modifications for each optimization procedure. The approach in Donti et al. is a general framework to derive exact solutions to constrained optimization problems. The approach in Donti et al. consists of three steps: completion (to find feasible solutions that satisfy any given equality constraints), correction (to find feasible solutions that satisfy any inequality constraints), and soft loss optimization (to find solutions that optimize the main objective while staying feasible). Constrained optimization problems can be generally written in the following way: min ƒ, such that g<=0, h=0. Here g≤0 is the inequality constraint and h=0 is the equality constraint. Completion first finds a solution that ensures h=0 is satisfied. Then correction will ensure g≤0 is satisfied while h=0. Finally, soft loss optimization optimizes ƒ while respecting the other constraints.

The example embodiments of FIG. 3 bypasses the completion step, because there are no equality constraints. The general approach described by Donti et al. is modified, in the examples described herein, to find approximate solutions instead of exact solutions. For policy optimization 202, feasibility is not ensured for the soft loss optimization step, but feasibility is ensured for the correction step. For constraint function optimization 204, the correction step is omitted, and soft loss optimization is used directly, which ensures feasibility in any event.

Some examples may use vanilla gradient descent, which is a well-known simple iterative procedure for optimization. Specifically, the correction step may optimize the constraint function g of the problem (not necessarily the same as the constraint function c used in ICL) until it satisfies the inequality condition(s). Because a general constrained problem is: min ƒ, such that g<=0, h=0, in the correction step the technique tries to ensure that g≤0 is satisfied. This g is a generic function with any input/output and is different from the constraint function c used in the overall constraint learning methods described herein, which usually receive a state-action pair (s, α) and return a constraint value scalar. The soft loss optimization step may optimize a penalty formulation of the main objective and the inequality constraint objective.

As shown in FIG. 3, these steps of the modified version of Donti et al. are shown as internal operation of the policy optimization 202 and constraint function optimization 204 procedures. Policy optimization 202 begins at process 302 in which the constraint function c and the policy π are initialized, e.g., to generate initial parameters (π₀, c₀) 212 described above with reference to FIG. 2. The initial parameters (π₀, c₀) 212 are provided as input to process 304, in which π is corrected (using the correction step described above) such J_{c}(π) is within β, i.e., J_{c}(π)≤β. At 306, Jᵣ(π) is optimized, i.e., the policy π is adjusted to maximize the reward.

Processes 304 and 306 are then iterated N times, wherein N is a predetermined number such as 500. At each iteration, the policy π is first corrected at 304 and then optimized for reward at 306.

After processes 304 and 306 have been iterated N times, the output (i.e. constraint function c and policy π, also denoted π* or πₖ depending on context) is provided to the constraint function optimization 204 procedure.

The constraint function optimization 204 procedure begins with process 308, in which the constraint function c is initialized (for the first iteration), and πₘᵢₓ is obtained by adding policy n (from the output of the policy optimization 202 procedure of the current epoch) to the set of policies Π, then deriving a mixture policy πₘᵢₓ from the set of policies Π. The weighted computation of the mixture policy is shown in Algorithm 1 above at lines 11, 13, and 15.

At process 310, the second utility of the mixture policy J_{c}(πₘᵢₓ) is optimized, such that the third utility J_{c}(π_{E}) is within 13. Process 310 is repeated a predetermined number of times M, such as M=25 times in some embodiments.

After process 310 has been repeated M times, or after another termination condition is satisfied, the constraint function optimization 204 procedure terminates. This marks the end of an epoch of alternation between the two optimization procedures 202, 204. In some embodiments, one or more additional epochs are performed, such as a predetermined number (e.g., 20) of epochs, or until a convergence condition or other termination condition is satisfied, as described above. At the end of each epoch, the optimized constraint function c and policy π are provided from the constraint function optimization 204 procedure to the policy optimization 202 procedure to begin the next epoch. In some examples, these are provided as output 220 denoted as (πₖ₊₁, cₖ₊₁) in FIG. 2 described above for the output of epoch k. In some examples, the final output 222 of constraint function optimization 204 after the final epoch (e.g., epoch n) is final constraint function cₙ.

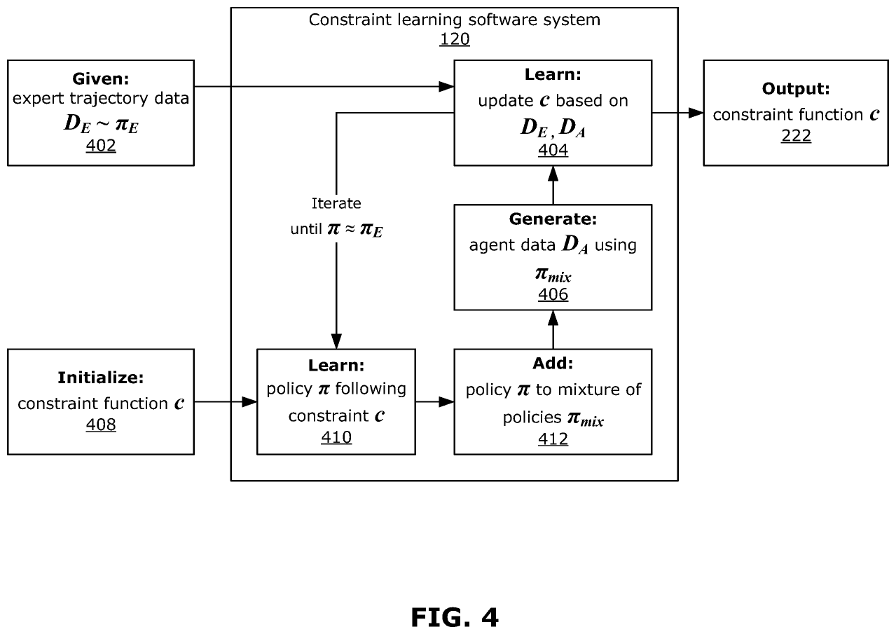

FIG. 4 is a further schematic diagram of the constraint learning process of FIGS. 2 and 3, implemented as an example constraint learning software system 120. In the example constraint learning software system 120 of FIG. 4, several components or software modules 404, 406, 410, 412 of the software system 120 are shown performing specific tasks. It will be appreciated that, whereas component 410 (which corresponds to the policy optimization procedure 202 of FIGS. 2-3) may be implemented in some embodiments using techniques similar to those described by Anwar et al. as described above, components 404, 406, and 412 (which correspond roughly to the constraint function optimization procedure 204 of FIGS. 2-3) apply different techniques from the maximum entropy approach of Anwar et al., instead applying the constrained min-max operations described above and summarized in Equation 4.

In FIG. 4, the constraint learning software system 120 includes several components or software modules 404, 406, 410, 412. Module 410 performs the policy optimization procedure 202 described above: in this example, after receiving the initialized constraint function c 408 (e.g., as part of initial parameters 212), module 410 is configured to learn a policy π while satisfying the constraint function c, using constrained reinforcement learning techniques such as those described above.

The output of module 410 is the optimized policy π (or policy π*), which is added to the mixture of policies πₘᵢₓ at module 412 (although the corresponding weight of the added policy π* is computed at a later step). At module 406, agent data D_{A} is generated based on πₘᵢₓ. The agent data represents actions taken by a reinforcement learning agent in the simulated environment, i.e., actions taken based on the current state and past states and actions. In some examples, the agent data may include a number of trajectories (i.e., progressions through a sequence of states as a result of performing a sequence of actions) for each policy in the mix of policies πₘᵢₓ. In some examples, the number of trajectories included in the agent data for a given policy is proportional to the weight of that policy.

At module 404, a neural network or other machine learning model is used to learn the constraint function c, using as input the agent data D_{A} as well as demonstration data (e.g., expert trajectory D_{E} 402), by applying constrained min-max operations such as those described above. The expert trajectory data D_{E} 402 is taken as representative of the expert policy π_{E} as constrained by constraint function c.

The output of module 404 is an updated constraint function c, which may be provided back to module 410 as output 220 denoted cₖ₊₁ as in FIG. 2 above. (The policy πₖ₊₁ shown in FIG. 2 denotes the current set of policies, πₘᵢₓ, following iteration k). The operations of modules 410, 412, 406, and 404 may then be repeated for one or more additional epochs (e.g., n epochs in total), as described above.

The final output 222 of module 404 after the final epoch is constraint function cₙ, as in FIG. 2 above.

Constraint Learning for Motion Planning

Some embodiments will be described herein with respect to the problem domain of autonomous driving. A system designed to perform autonomous driving may include many different software components configured to manage different aspects of the driving process, such as prediction, perception, planning, etc. The planning component is usually divided into three parts: mission planning (i.e., finding a path involving roads, intersections, highways, etc. to take the vehicle from a start location, e.g. Chicago, to an end location, e.g. New York City), behavior planning (i.e., generating high-level driving actions while following a mission path, such as overall deceleration, overall acceleration, yielding, or changing lanes), and motion planning (i.e., generating low-level control signals, such as immediate steering and immediate acceleration, to execute a high-level driving action).

Some embodiments described herein can be used to generate inputs to the motion planning subcomponent of an autonomous driving system. Most motion planning subcomponents plan from a start position to an end position, and require a constraint specification to achieve the objectives of safety, mobility, comfort, etc. These constraints are manually specified, but such constraints are typically unable to capture the complexity of the driving process. An alternative to such an explicitly-defined constraint specification is to first learn a constraint function using inverse constraint learning techniques described herein, then use this constraint function as an input to the local planner.

Thus, some example embodiments described herein may enable the learning behavioral constraints from demonstrations of expert driving behavior, thereby generating a constraint function for use by an autonomous driving system.

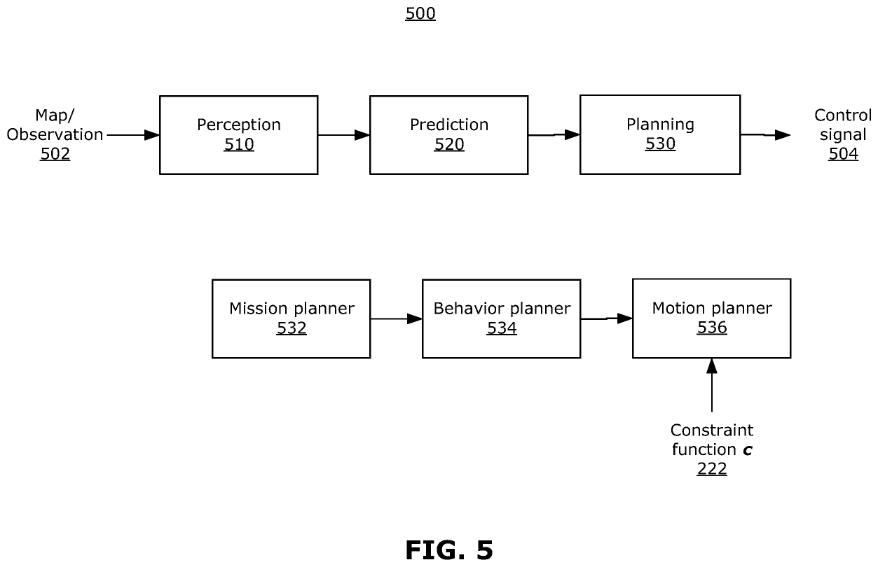

FIG. 5 shows a schematic diagram of an example autonomous driving system 500 having a motion planning component 536 that operates in accordance with a constraint function c 222 determined according to examples described herein, such as the examples of constraint learning described above with reference to FIGS. 1-4. The autonomous driving system 500 includes the components described above: a perception module 510 that receives map and/or observation data 502 as input, a prediction module 520, and a planning module 530 that generates a control signal 504 as output, wherein the planning module 530 includes three sub-components: a mission planner 532, a behavior planner 534, and a motion planner 536 that operates in accordance with the received constraint function c 222.

Some example embodiments described herein may exhibit one or more advantages in the context of autonomous driving. First, the ability of some examples to handle soft constraints may enable the learning of a wide range of constraint functions for different autonomous driving scenarios. Some of these scenarios could include:
1. Constraints for pedestrians: e.g., stay at a conservative distance from pedestrians, which would mean a high cost for regions occupied by and near pedestrians.
2. Constraints for road boundaries: e.g., stay within the road boundaries and appropriate lane; going into the opposite lane incurs a cost but not a high cost, which means that the vehicle is allowed to go into the opposite lane briefly and when absolutely required.
3. Constraints for other vehicles: e.g., depending on the other vehicle's speed/acceleration, a region is defined around the other vehicle such that going within the region will incur a cost. The autonomous driving system could briefly violate the constraint against entering this region depending on the threshold for mistakes (i.e. cost threshold β).
4. Constraints for traffic rules: e.g., do not enter the intersection depending on the state of the traffic light (red or green).

Once these constraints are learned from demonstrations, example embodiments could provide them all to the motion planner 536 to provide rules and constraints for the motion planner 536 to obey during operation of the vehicle.

Example Method for Learning Constraints from Demonstrations

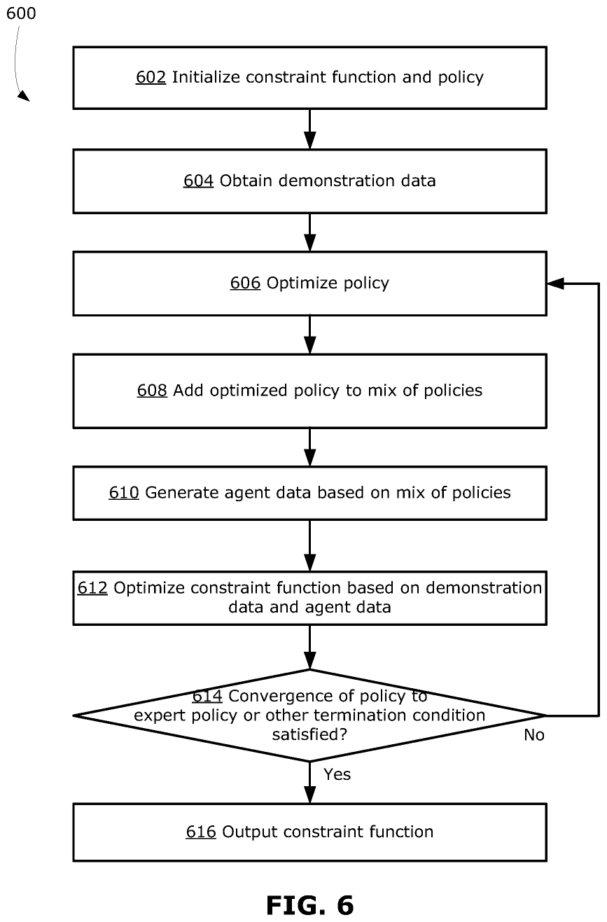

FIG. 6 is a flowchart showing operations of a method 600 for learning constraints from demonstrations. The method 600 will be described with reference to the example constraint learning software system 120 described above with reference to FIGS. 1-5; however, it will be appreciated that other examples of the techniques described herein could be used to perform one or more of the steps of method 600.

At 602, the policy and constraint function are initialized, for example as initial parameters 212 of FIG. 2, including an initial policy π₀ and an initial constraint function c₀. In some embodiments, the constraint function is initialized as initialized constraint function c 408 of FIG. 4.

At 604, demonstration data is obtained, for example as expert trajectory data D_{E} 402 of FIG. 4. The demonstration data can include, or can be used to infer, a sequence of actions, each action being taken in the context of a respective state of a demonstration environment in which the demonstration is performed.

At 606, policy optimization 202 is performed according to one of the techniques described above to solve the optimization problem of Equation 3, for example by module 410 of FIG. 4, thereby generating an adjusted policy π* (also called the optimized policy).

At 608, the adjusted policy π* (e.g., as part of the output 216 of policy optimization 202 in FIG. 2) is added to the mix of policies πₘᵢₓ (i.e. the set of policies Π), for example by module 412 of FIG. 4.

At 610, agent data D_{A} is generated based on the mix of policies πₘᵢₓ, for example by module 406 of FIG. 4.

At 612, constraint function optimization 204 is performed according to one of the techniques described above to solve the optimization problem of Equation 4, for example by module 404 of FIG. 4 updating the current constraint function, and selecting a selected policy from the set of policies as the new current policy πₖ₊₁, based on the agent data D_{A} and the expert trajectory data D_{E} 402.

At 614, if a terminating condition is satisfied (such as convergence of the policy π to the expert policy π_{E}, or completion of a predetermined number of epochs such as n=20), the method 600 proceeds to step 616. Otherwise the method 600 returns to step 606, providing the (selected) current policy πₖ₊₁ and the (now adjusted) current constraint function cₖ₊₁, wherein k denotes the epoch just completed.

At 616, the current constraint function, e.g., final constraint function cₙ 222, is provided as the output of the method 600.

Experimental Results

Several experiments have been conducted to assess the constraint function 222 learned by example embodiments described herein.

Environments used for the experiments included Gridworld (A, B) (7×7 gridworld environments adapted from the open source repository github.com/yrlu/irl-imitation, in which the action space consists of 8 discrete actions including 4 nominal directions and 4 diagonal directions), CartPole (MR, Mid) (variants of the CartPole environment from OpenAI™ Gym wherein the objective is to balance a pole for as long as possible, starting in a region of high constraint value, and the objective is to move to a region of low constraint value and balance the pole there, while the constraint function is being learned), and the HighD dataset (environment constructed using ≈100 trajectories of length ≥1000 from the HighD highway driving dataset, using an environment adapted from the Wise-Move framework, and in which, for each trajectory, the agent starts on a straight road on the left side of the highway, and the objective is to reach the right side of the highway without colliding into any longitudinally moving cars, with an action space consisting of a single continuous action, i.e. acceleration). For the HighD dataset environment, the true constraint function was unknown. Instead, the objective was to learn a constraint function that is able to capture the relationship between the agent's velocity and the distance to the car in the front.

Two baseline approaches were used to compare against the example embodiment being tested.

The first baseline approach was GAIL-Constraint, i.e. Generative Adversarial Imitation Learning: an imitation learning method that can be used to learn a policy that mimics the expert policy, wherein the discriminator can be considered as a local reward function that incentivizes the agent to mimic the expert, and it is assumed that the agent is maximizing the reward r(s, α): =r₀(s, α)+log(1−c(s, α)) where r₀ is the given true reward, and where the log term corresponds to the GAIL's discriminator. When c(s, α)=0, the discriminator reward is 0, and when c(s, α)=1, the discriminator reward tends to −∞.

The second baseline approach was Inverse constrained reinforcement learning (ICRL), which is a recent method that is able to learn arbitrary Markovian neural network constraint functions; however, it can only handle hard constraints.

For both these baseline approaches, a similar training regime was used as was adopted by Anwar et al.; however, the constraint function architecture is kept fixed across all experiments (i.e. the two baseline approaches and the embodiment being tested).

Two metrics were used in the experiments:

1. Constraint Mean Squared Error (CMSE) is computed as the mean squared error between the true constraint function and the recovered constraint function on a uniformly discretized state-action space for the respective environment.

2. Normalized Accrual Dissimilarity (NAD) is computed as follows. Given the policy learned by the method, compute an agent dataset of trajectories. Then, the accrual (state-action visitation frequency) is computed for both the agent dataset and the expert dataset over a uniformly discretized state-action space, which is the same as the one used for CMSE. Finally, the accruals are normalized to sum to 1, and the Wasserstein distance (using the Python Optimal Transport library) is computed between the accruals.

The results were as follows:

TABLE 1
Constraint Mean Squared Error

| | Environment | | | |
|---|---|---|---|---|
| Algorithm | Gridworld (A) | Gridworld (B) | CartPole (MR) | CartPole (Mid) |
| GAIL-Constraint | 0.31 ± 0.01 | 0.25 ± 0.01 | 0.12 ± 0.03 | 0.25 ± 0.02 |
| ICRL | 0.11 ± 0.02 | 0.21 ± 0.04 | 0.21 ± 0.16 | 0.27 ± 0.03 |
| ICL (tested embodiment) | 0.08 ± 0.01 | 0.04 ± 0.01 | 0.02 ± 0.00 | 0.08 ± 0.05 |

TABLE 2
Normalized Accrual Dissimilarity

| | Environment | | | |
|---|---|---|---|---|
| Algorithm | Gridworld (A) | Gridworld (B) | CartPole (MR) | CartPole (Mid) |
| GAIL-Constraint | 1.76 ± 0.25 | 1.29 ± 0.07 | 1.80 ± 0.24 | 7.23 ± 3.88 |
| ICRL | 1.73 ± 0.47 | 2.15 ± 0.92 | 12.32 ± 0.48 | 13.21 ± 1.81 |
| ICL (tested embodiment) | 0.36 ± 0.10 | 1.26 ± 0.62 | 1.63 ± 0.89 | 3.04 ± 1.93 |

Reported Metrics (Mean±Std. Deviation Across 5 Seeds) for the Conducted Experiments

These results indicate the following:

1. Lowest CMSE. While the tested embodiment was not guaranteed to produce the true constraint function (because true constraints are typically unidentifiable from demonstrations), the experiments indicated that the tested embodiment was able to learn constraint functions that strongly resemble the true constraint function, as can be seen by the low CMSE scores of the tested embodiment relative to the two baseline approaches. The GAIL-Constraint approach was able to find the correct constraint function for all environments except CartPole-Mid; however, the recovered constraint was more diffused throughout the state action space than for the tested embodiment. In contrast, the tested embodiment recovered a constraint that was quite sharp, even without a regularizer. Because CartPole-Mid is a difficult constraint to learn in comparison to the other constraints, this result indicates favorable performance by the tested embodiment. On the other hand, the ICRL approach was able to find the correct constraint function only for CartPole-MR, and to a less acceptable degree, for Gridworld A. This is surprising as ICRL should be able to theoretically learn any arbitrary constraint function (note that the experiments used the settings in Anwar et al. as much as possible), and one would expect it to perform better than GAIL-Constraint. The possible explanation for this is two-fold. One, only simple constraints were considered, and for more complex settings (constraints or environments), ICRL may not be able to perform as well. Second, ICRL may require more careful hyperparameter tuning for each constraint function setting, even with the same environment, depending on the constraint. This is ascertained by the fact that with the same hyperparameter settings, ICRL works for CartPole-MR, but not for CartPole-Mid.

2. Lowest NAD. Similarly, a strong resemblance was found between the accruals recovered by the tested embodiment and the expert, as can be seen by the low NAD scores of the tested embodiment. As expected, the accruals of the tested embodiment were similar to the expert accruals, which is due to the fact that the tested embodiment was able to learn the true constraint function to a better degree than the other approaches. GAIL-Constraint accruals were similar to the expert accruals except for CartPole-Mid environment, where it was also unable to learn the correct constraint function. Overall, this indicates that GAIL was able to correctly imitate the constrained expert across most environments, as one would expect. On the other hand, ICRL accruals were even worse than GAIL, indicating that it was unable to satisfactorily imitate the constrained expert, even on the environments for which it was able to generate a somewhat satisfactory constraint function. Again, this may indicate that more careful hyperparameter tuning may have been necessary, unlike the tested embodiment, which only tuned β.

Not shown in Tables 1 and 2 are the HighD driving dataset results. Overall, for the HighD driving dataset environment, all the three approaches were able to find the lower boundary that corresponds to the 4-5 second gap rule in highway driving. However, the tested embodiment was the only approach which didn't assign a high constraint value to large gaps. A possible explanation for this is that the other approaches were unable to explicitly ensure that expert trajectories were assigned a low constraint value, whereas the tested embodiment was able to do so through the constraint value adjustment step.

General

Although the present disclosure describes methods and processes with steps in a certain order, one or more steps of the methods and processes may be omitted or altered as appropriate. One or more steps may take place in an order other than that in which they are described, as appropriate.

Although the present disclosure is described, at least in part, in terms of methods, a person of ordinary skill in the art will understand that the present disclosure is also directed to the various components for performing at least some of the aspects and features of the described methods, be it by way of hardware components, software or any combination of the two. Accordingly, the technical solution of the present disclosure may be embodied in the form of a software product. A suitable software product may be stored in a pre-recorded storage device or other similar non-volatile or non-transitory computer readable medium, including DVDs, CD-ROMs, USB flash disk, a removable hard disk, or other storage media, for example. The software product includes instructions tangibly stored thereon that enable a processing device (e.g., a personal computer, a server, or a network device) to execute examples of the methods disclosed herein.

The present disclosure may be embodied in other specific forms without departing from the subject matter of the claims. The described example embodiments are to be considered in all respects as being only illustrative and not restrictive. Selected features from one or more of the above-described embodiments may be combined to create alternative embodiments not explicitly described, features suitable for such combinations being understood within the scope of this disclosure.

All values and sub-ranges within disclosed ranges are also disclosed. Also, although the systems, devices and processes disclosed and shown herein may comprise a specific number of elements/components, the systems, devices and assemblies could be modified to include additional or fewer of such elements/components. For example, although any of the elements/components disclosed may be referenced as being singular, the embodiments disclosed herein could be modified to include a plurality of such elements/components. The subject matter described herein intends to cover and embrace all suitable changes in technology.

The content of all published papers identified in this disclosure, are incorporated herein by reference.

1. A method for learning a constraint function consistent with a demonstration, comprising:
obtaining:
demonstration data representative of the demonstration, the demonstration data comprising a sequence of actions, each action being taken in the context of a respective state of a demonstration environment;
an initial policy operable to determine an action for an agent based on a current state of an agent environment, such that a current policy is set to the initial policy; and
an initial constraint function, such that a current constraint function is set to the initial constraint function;
performing a policy optimization procedure to adjust the current policy, thereby generating an adjusted policy;
adding the adjusted policy to a set of policies;
performing a constraint function optimization procedure to:
generate a mixture policy, based on the set of policies, that defines a second utility comprising the current constraint function applied to the mixture policy; and
adjust the current constraint function to maximize the second utility,
such that a third utility is within a constraint threshold, the third utility being the current constraint function applied to the demonstration data; and providing the current constraint function as the constraint function.

2. The method of claim 1, further comprising, before providing the adjusted constraint function as the constraint function:
repeating, one or more times, the steps of performing the policy optimization procedure, adding the adjusted policy to the set of policies, and performing the constraint function optimization procedure.

3. The method of claim 2, wherein:
performing the policy optimization procedure comprises:
adjusting the current policy to maximize a first utility comprising a reward function applied to the current policy,
such that the second utility is within a constraint threshold.

4. The method of claim 3, wherein:
adjusting the current policy to maximize the first utility such that the second utility is within the constraint threshold comprises:
performing constrained optimization using forward constrained reinforcement learning.

5. The method of claim 4, wherein:
the forward constrained reinforcement learning uses vanilla gradient descent.

6. The method of claim 2, wherein:
the constraint function optimization procedure uses vanilla gradient descent to adjust the current constraint function to maximize the second utility.

7. The method of claim 2, wherein:
the constraint function optimization procedure comprises:
training a neural network to optimize the second utility while maintaining the third utility within the constraint threshold.

8. The method of claim 1, wherein:
generating the mixture policy comprises computing a weighted mixture of the set of policies.

9. The method of claim 2, wherein:
the demonstration data comprises a plurality of expert trajectories;
applying the current constraint function to the current policy comprises:
generating agent data, comprising a plurality of agent trajectories based on the mixture policy; and
computing the second utility by applying the current constraint function to the plurality of agent trajectories; and
applying the current constraint function to the demonstration data comprises:
computing the third utility by applying the current constraint function to each expert trajectory of the plurality of expert trajectories.

10. The method of claim 2, further comprising operating an autonomous driving system by:
operating a motion planner of the autonomous driving system in accordance with the constraint function.

11. A system, comprising:
a processing device;
a memory storing thereon machine-executable instructions that, when executed by the processing device, cause the system to learn a constraint function consistent with a demonstration by:
obtaining:
demonstration data representative of the demonstration, the demonstration data comprising a sequence of actions, each action being taken in the context of a respective state of a demonstration environment;
an initial policy operable to determine an action for an agent based on a current state of an agent environment, such that a current policy is set to the initial policy; and
an initial constraint function, such that a current constraint function is set to the initial constraint function;
performing a policy optimization procedure to adjust the current policy, thereby generating an adjusted policy;
adding the adjusted policy to a set of policies;
performing a constraint function optimization procedure to:
generate a mixture policy, based on the set of policies, that defines a second utility comprising the current constraint function applied to the mixture policy; and
adjust the current constraint function to maximize the second utility,
such that a third utility is within a constraint threshold, the third utility being the current constraint function applied to the demonstration data; and
providing the current constraint function as the constraint function.

12. The system of claim 11, wherein the instructions, when executed by the processing device, further cause the system to:
before providing the adjusted constraint function as the constraint function:
repeat, one or more times, the steps of performing the policy optimization procedure, adding the adjusted policy to the set of policies, and performing the constraint function optimization procedure.

13. The system of claim 12, wherein:
performing the policy optimization procedure comprises:
adjusting the current policy to maximize a first utility comprising a reward function applied to the current policy,
such that the second utility is within a constraint threshold.

14. The system of claim 13, wherein:
adjusting the current policy to maximize the first utility such that the second utility is within the constraint threshold comprises:
performing constrained optimization using forward constrained reinforcement learning.

15. The system of claim 14, wherein:
the forward constrained reinforcement learning uses vanilla gradient descent.

16. The system of claim 15, wherein:
the constraint function optimization procedure uses vanilla gradient descent to adjust the current constraint function to maximize the second utility.

17. The system of claim 12, wherein:
the constraint function optimization procedure comprises:
training a neural network to optimize the second utility while maintaining the third utility within the constraint threshold.

18. The system of claim 12, wherein:
the demonstration data comprises a plurality of expert trajectories;
applying the current constraint function to the current policy comprises:
generating agent data, comprising a plurality of agent trajectories based on the mixture policy; and
computing the second utility by applying the current constraint function to the plurality of agent trajectories; and
applying the current constraint function to the demonstration data comprises:
computing the third utility by applying the current constraint function to each expert trajectory of the plurality of expert trajectories.

19. An autonomous driving system, comprising:
a motion planner configured to operate in accordance with a constraint function learned in accordance with the method of claim 1.

20. A non-transitory computer-readable medium having instructions tangibly stored thereon that, when executed by a processing device of a computing system, cause the computing system to learn a constraint function consistent with a demonstration, by:
obtaining:
demonstration data representative of the demonstration, the demonstration data comprising a sequence of actions, each action being taken in the context of a respective state of a demonstration environment;
an initial policy operable to determine an action for an agent based on a current state of an agent environment, such that a current policy is set to the initial policy; and
an initial constraint function, such that a current constraint function is set to the initial constraint function;
performing a policy optimization procedure to adjust the current policy, thereby generating an adjusted policy;
adding the adjusted policy to a set of policies;
performing a constraint function optimization procedure to:
generate a mixture policy, based on the set of policies, that defines a second utility comprising the current constraint function applied to the mixture policy; and
adjust the current constraint function to maximize the second utility,
such that a third utility is within a constraint threshold, the third utility being the current constraint function applied to the demonstration data; and
providing the current constraint function as the constraint function.
